(19) United States
(12) Patent Application Publication
(10) Pub. No.: US 2015/0026715 A1
(43) Pub. Date: Jan. 22, 2015

(54) In-stream video advertising using a user-choice-based ad unit

(71) Applicant: Visible Measures Corp., Boston, MA (US)

(72) Inventors: David Bernstein, Newton, MA (US); Hung P. Nguyen, San Francisco, CA (US)

(73) Assignee: Visible Measures Corp., Boston, MA (US)

(21) Appl. No.: 13/947,682

(22) Filed: Jul. 22, 2013

(51) Int. Cl. H04N 21/435

(52) U.S. Cl. CPC H04N 21/435
USPC 725/32

(57) ABSTRACT

A choice-based ad unit format wherein a user chooses his or her pre-roll ad or can choose to wait for the main content to load. Once the video advertisement selected loads, the user can then choose to skip the ad or view the entire ad experience. Preferably, the ad viewing experience is integrated with a site to enable the ad unit to have unlimited access to in-stream inventory that is otherwise available from the site.

### TECHNICAL FIELD

This disclosure relates generally to digital video advertising.

### BACKGROUND OF THE RELATED ART

In May 2006, the Interactive Advertising Bureau (IAB) defined a video ad as a commercial that may appear before, during, or after a variety of content in a player environment. One type of digital video ad experience is so-called “in-stream video advertising”—which refers to a video ad experience either viewed within or around video content from a video player (such as a web browser, or other rendering client). In-stream video ads may be linear, in which case they are presented before, in the middle of, or after the video content is consumed by the user, or non-linear, in which case the ad runs concurrently with the video content so that users see both.

The IAB's Video Ad Serving Template (VAST) specification is a universal XML schema for serving ads to digital video players, and it describes expected video player behavior when executing VAST-formatted ad responses. VAST provides for a common in-stream advertising protocol for video players irrespective of whether publishers use disparate proprietary video players. The first version of VAST was introduced in 2008, and it was widely adopted throughout the industry. The current version is VAST 3.0, released in July 2012, and this specification defines additional features and functionality to improve support for in—stream ad display and reporting.

VAST supports only simple in-stream video ad formats that are not executable. To support more complex ad formats, IAB has developed VPAID, or the Video Player Ad-Serving Interface Definition. This additional specification establishes a common interface between video players and ad units, thereby enabling richer interactive in-stream ad experiences. In particular, VPAID establishes a common communication protocol between video players and ad units that allows a single executable ad to be displayed in-stream with the publisher's video content in any compliant video player. According to the specification, an executable ad is one that requires software to be executed as part of the ad playback.

### BRIEF SUMMARY

According to this disclosure, a VPAID-compliant ad unit, sometimes referred to herein as a “user-choice ad unit,” supports at least first and second child media players that may be referenced by a parent video player (e.g., a VPAID-compliant media player). The parent video player delegates to the VPAID-compliant ad unit via a standard VPAID interface. It is assumed that a user (viewer) has taken some action (e.g., selection of a link on a page) to cause the ad unit to render in the parent video player. The action seeks some publisher (or “main”) content. The first and second child media players provide in-ad-unit display areas for respective first and second in-stream video ads, one of which may be selected by a user for viewing prior to the display of the main publisher content originally sought. If neither the first nor the second video ads are selected after a time-out, the publisher's main content plays. Preferably, selection of one of the videos by the user results in a user-initiated view count to be incremented (and available as a metric, publicly-available) on a publisher site. Upon selection, the selected video ad expands to fill the parent video player display frame. At any point during the rendering of the video, the user may click-through to an advertiser site or page; after a given time-out, the user may skip through to the main content (rendered in the parent video player). In the alternative, the main content plays after the video ad completes. Complete viewing metrics (for the ad video) are then tracked, e.g., using a conventional measurement application programming interface (API).

The disclosed technique provides a choice-based ad unit format wherein a user chooses his or her pre-roll ad or can choose to wait for the main content to load. Once the video advertisement selected loads, the user can then choose to skip the ad or view the entire ad experience. Preferably, the ad viewing experience is integrated with a site to enable the ad unit to have unlimited access to in-stream inventory that is otherwise available from the site.

The foregoing has outlined some of the more pertinent features of the subject matter. These features should be construed to be merely illustrative.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 is a block diagram of a digital video advertising service provider infrastructure;

FIG. 2 is a process flow of an in-stream user choice-based video ad experience according to the technique herein;

FIG. 3 illustrates a client-side user interface (UI) wherein a parent media player exposes first and second videos that may be selected by a user;

FIG. 4 illustrates the user interface in FIG. 3 with a child player that has been expanded into the parent media player to display the user-selected creative;

FIG. 5 illustrates the ad unit of this disclosure and its operation within a compatible parent media player.

### DETAILED DESCRIPTION OF AN ILLUSTRATIVE EMBODIMENT

The disclosed method may be practiced in association with a computing infrastructure comprising one or more data processing machines.

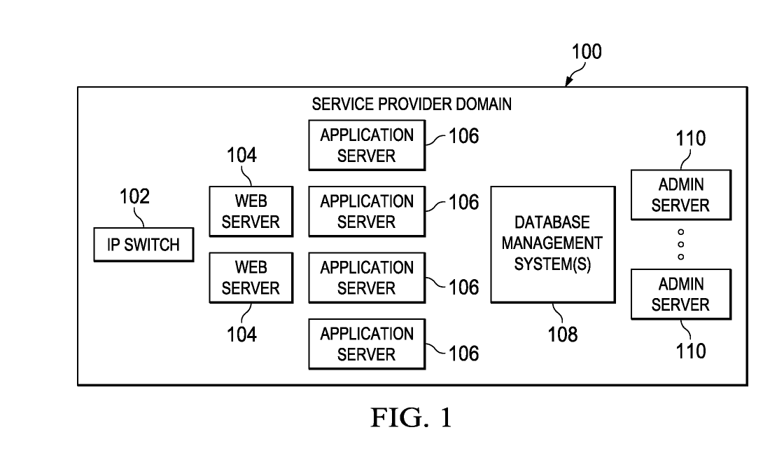

A representative infrastructure is a service that provides a choice-based video advertising network. In one aspect, the video advertising network provides tools that may be used to promote video ads as content across online content publishers (Internet-accessible video destinations). A representative service (an ad network) of this type is Viewable Media™ provided by Visible Measures® of Boston, Mass. This type of service (in whole or in part) may be implemented on or in association with a service provider infrastructure 100 such as seen in FIG. 1. A representative infrastructure of this type comprises an IP switch 102, a set of one or more web server machines 104, a set of one more application server machines 106, a database management system 108, and a set of one or more administration server machines 110. Without meant to be limiting, a representative technology platform that implements the service comprises machines, systems, sub-systems, applications, databases, interfaces and other computing and telecommunications resources. A representative web server machine comprises commodity hardware (e.g., Intel-based), an operating system such as Linux, and a web server such as Apache 2.x (or higher). A representative application server machine comprises commodity hardware, Linux, and an application server such as WebLogic 9.2 (or later). The database management system may be implemented as an Oracle (or equivalent) database management package running on Linux. The infrastructure may include a name service, FTP servers, administrative servers, data collection services, management and reporting servers, other backend servers, load balancing appliances, other switches, and the like. Each machine typically comprises sufficient disk and memory, as well as input and output devices. The software environment on each machine includes a Java virtual machine (JVM) if control programs are written in Java. Generally, the web servers handle incoming business entity provisioning requests, and they export a management interface. The application servers manage the basic functions of the service including, without limitation, business logic.

One or more functions of such a technology platform may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The front-end of the above-described infrastructure is also representative of a conventional third party web site.

Client devices access service provider infrastructure as described to retrieve content, including HTML, media players, video content, and other objects. A typical client device is a personal computer, laptop, mobile device, tablet, or the like. A representative mobile device is an Apple iPad® or iPad2, iPad Mini, an Android™-based smartphone or tablet, a Windows®-based smartphone or tablet, or the like. A device of this type typically comprises a CPU (central processing unit), such as any Intel- or AMD-based chip, computer memory 304, such as RAM, and a flash drive. The device software includes an operating system (e.g., Apple iOS, Google® Android™, or the like), and generic support applications and utilities. The device may also include a graphics processing unit (GPU), and a touch-sensing device or interface configured to receive input from a user's touch. The touch-sensing device typically is a touch screen. The mobile device comprises suitable programming to facilitate gesture-based control, in a manner that is known in the art.

The client is not limited to a mobile device, as it may be a conventional desktop, laptop or other Internet-accessible machine running a web browser. Content retrieved to the client may be rendered in a browser, within a mobile app, or other rendering engine.

The above-described server-side technologies are compliant with VAST and VPAID (or their equivalents). Further, client media players also are compliant with VAST and VPAID. The reader's familiarity with these standards is presumed in the following.

### In-Stream Video Advertising with user Choice-Based Ad Unit

With the above as background, the technique of this disclosure is now described.

According to the technique, a VPAID-compliant ad unit, sometimes referred to herein as a “user-choice ad unit,” supports at least first and second child media players that may be referenced by a parent video player (e.g., a VPAID-compliant media player). The parent video player delegates to the VPAID-compliant ad unit via a standard VPAID interface. It is assumed that a user (viewer) has taken some action (e.g., selection of a link on a page) to cause the ad unit to render in the parent video player. The action seeks some publisher (or “main”) content. The first and second child media players provide in-ad-unit display areas for respective first and second in-stream video ads, one of which may be selected by a user for viewing prior to the display of the main publisher content originally sought. If neither the first nor the second video ads are selected after a time-out, the publisher's main content plays. Preferably, selection of one of the videos by the user results in a user-initiated view count to be incremented (and available as a metric, publicly-available) on a publisher site, on a publisher site from which the videos originate, on a video network, or the like. Upon selection, the selected video ad expands to fill the parent video player display frame. At any point during the rendering of the video, the user may click-through to an advertiser site or page; after a given time-out, the user may skip through to the main content (rendered in the parent video player). In the alternative, the main content plays after the video ad completes. Complete viewing metrics (for the ad video) are then tracked, e.g., using a conventional measurement application programming interface (API).

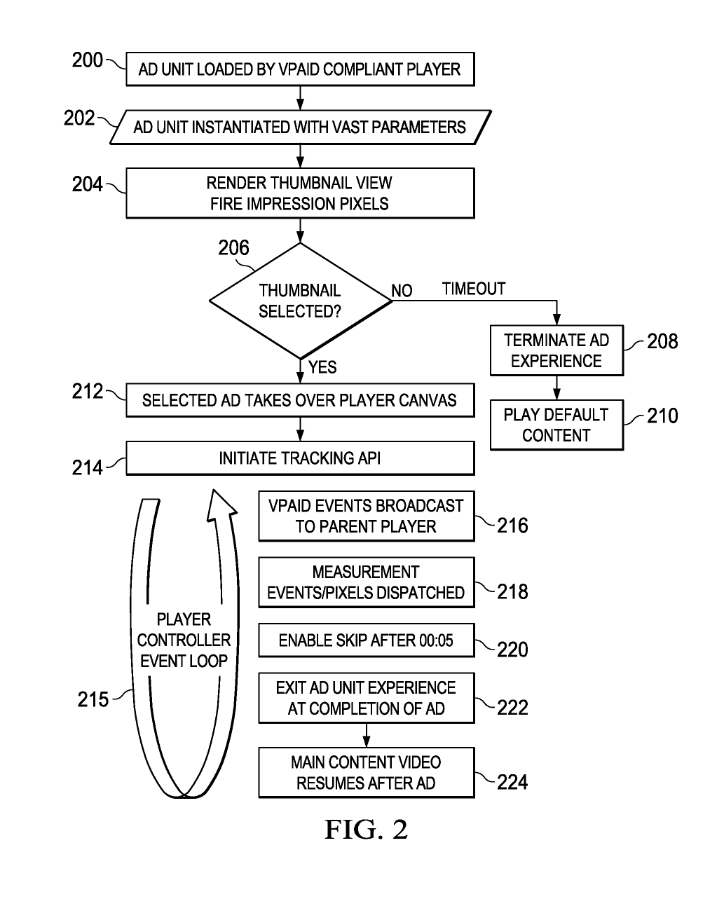

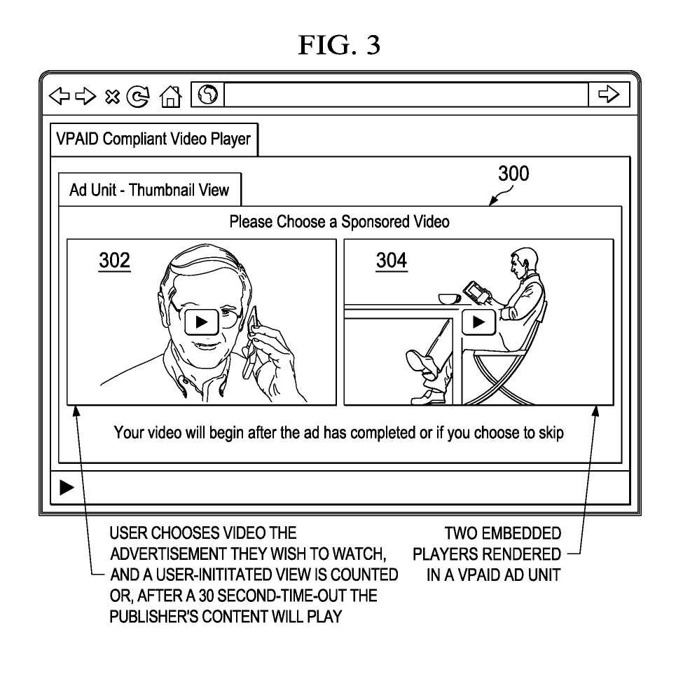

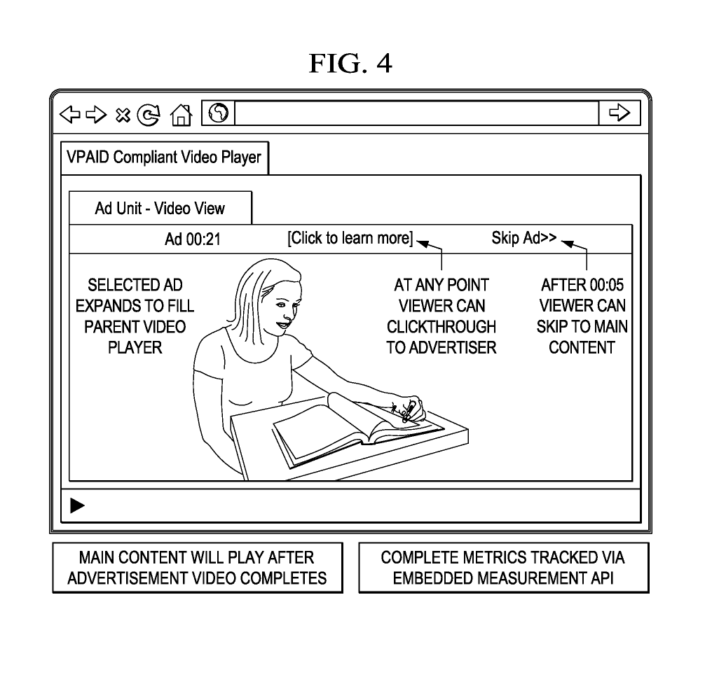

FIG. 2 illustrates the process, and FIGS. 3-4 illustrate a representative client user interface and the rendering of the in-stream ad unit.

With reference to FIG. 2, the routine starts at step 200 when the user-choice ad unit of this disclosure is loaded by a VPAID-compliant media player. As noted above, typically the ad unit is loaded when the viewer takes some action with respect to a referring page. That action typically is selection of a link to a publisher's main content. At step 202, the ad unit is instantiated with VAST AdParameters. At step 204, a thumbnail view is rendered, such as shown in FIG. 3. At step 204, impression pixels are fired by the ad unit to begin monitoring of the viewer's activity with respect to the ad unit. The thumbnail view illustrates first and second embedded child players 302 and 304 within the parent media player 300. Each of the first and second child players displays a thumbnail of a video, and a prompt (“Please Choose a Sponsored Video”) may be provided to facilitate this process. Referring back to FIG. 2, a test at step 206 is then executed to determine whether one of the thumbnails has been selected. If, following a configurable timeout (e.g., up to 30 seconds), the outcome of the test at step 206 is negative, the routine branches to step 208 to terminate the ad-unit experience. At step 210, the child players disappear and the main publisher content is then rendered in the parent media player.

If, however, the outcome of the test at step 206 indicates that the user has selected one of the thumbnails, the process continues at step 212 with the selected ad taking over the parent player canvas. Typically, this is achieved by having the selected child player (the one that supports the ad selected) expand to fill (or substantially fill, or at least partially fill) the video frame of the parent media player. To scale the selected child player, the ad unit obtains the dimensions of the parent player, e.g., over the VPAID interface, and then resizes the thumbnail to match the size of the parent player video canvas. At step 214, a tracking API is initiated. A set of actions associated with a Player Controller (as described in more detail below) event loop 215 are then carried out or otherwise available to be carried out depending on the viewer's action with respect to the ad experience. Thus, at step 216, VPAID events are broadcast to the parent media player. At step 218, measurement events/pixels are dispatched. Steps 216 and 218 typically are not discrete steps; these actions are event handlers that are triggered one or more times during the event loop. At step 220, and as illustrated in FIG. 4, a Skip Ad control in the child player is activated to enable the user to skip a remainder of the video ad. The skip timing may be configurable. As also shown in FIG. 4, the child player (or the ad itself) may include a “Click to learn more” link to the publisher of the ad, and selection of that link opens a new tab/window and navigates the user to the ad publisher's site or page. At step 222, the user-choice experience is exited upon completion of the ad. The main video content is then rendered (or resumes) at step 224. This completes the process.

As a variant, and to increase the overall clicks on the ad unit, the countdown (step 208) may be eliminated so that the user assumes he/she must click and choose one of the displayed ads.

The child players may be positioned in other than the side-by-side manner shown in FIG. 3. Thus, for example, one child player may be placed above the other child player. However configured, portions of a child player may overlap another child player. There may be more than two child players if additional ad choices are desired.

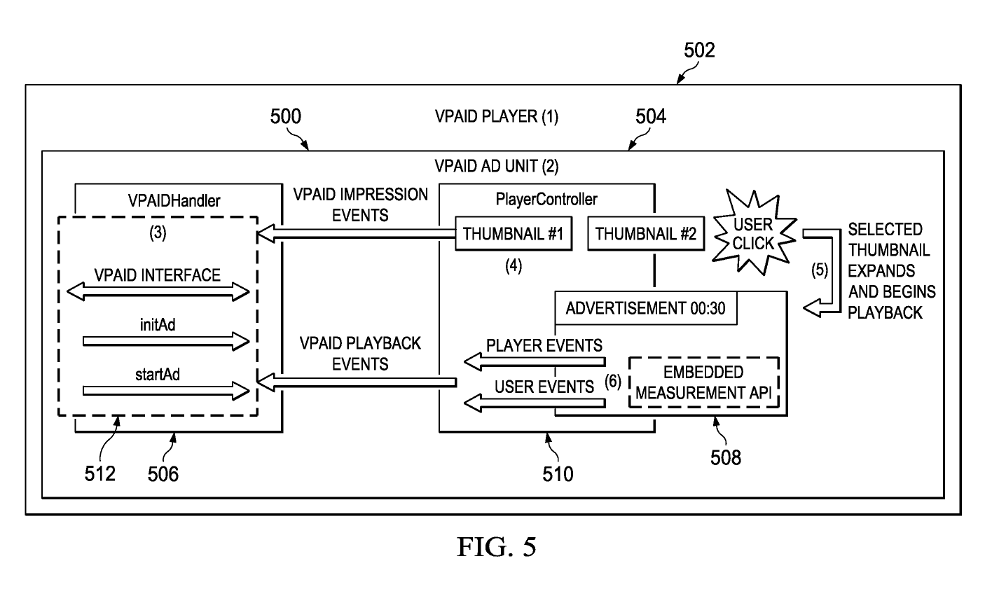

FIG. 5 illustrates the ad unit entity of this disclosure and its operation in more detail. Preferably, the ad unit entity is implemented as a compiled object in Adobe Flash SWF file format that is loaded into a player (the parent media player, as referenced above) at runtime. The entity preferably contains all of the logic responsible for executing ad behavior, rendering of thumbnails and video, as well as tracking functionality. The IAB generally refers to this type of structure as a VPAID ad unit, or a VPAID-enabled ad unit. According to the IAB specifications referenced above, in general VPAID ad units are loaded into VPAID-compliant VPAID-enabled players (hosts); the two communicate over a VPAID interface, which is a standard protocol that enables the two to interact to deliver the ad experience. Implementation of the ad unit entity does not require any modification or customization to the VPAID-compliant host player, which operates conventionally.

FIG. 5 illustrates the ad unit entity 500 loaded into the player 502, typically at runtime. In one example embodiment, the ad unit is implemented as a Flash SWF, with the application logic implemented in ActionScript 3.0 classes. As shown in FIG. 5, the classes comprise a main Flash document class “container” 504, a VPAID Handler 506, a Player class 508, and a Player Controller 510. The main container 504 acts as an entry point into the ad unit. The VPAID Handler 506 is the class that implements the VPAID Interface 512 and handles all interaction with the VPAID-enabled (host) player 502 including, without limitation, events dispatched to the player 502, and methods invoked (on the ad unit) by the player. The Player class 508 (e.g., YouTubePlayer) is the class that implements the individual ad thumbnail and ad video player behavior. Class 508 is a wrapper around the underlying YouTube (or other) player and that serves to extend a Player base class, thereby enabling the original YouTube (or other) video source to be replaced with another video player source/technology according to the technique herein. The Player Controller 510 is the class the implements the behavior/rules governing execution of the ad unit, and that coordinates between the user and the ad video thumbnails and the ad video player(s). As noted above, preferably the classes are compiled into an object that is loaded and executed at runtime in the parent media player. The SWF object may be generated using Adobe Flash, Flash Builder, as well as through other open source and third party tools.

As shown in FIG. 5, in operation, the VPAID player 500 calls an ad server (not shown) and, at step (1), receives back a VAST response that includes the ad unit (in the form of the VPAID SWF object) and a configuration document, typically XML-based. At step (2), the VPAID player 502 (i.e. the parent media player) loads the VPAID ad unit SWF 500. At step (3), the VPAID player 502 initializes the ad and begins interaction with using the VPAID Interface 512. At step (4), the Player Controller 510 instance creates the thumbnails and first impression events. At step (5), the user selection (of one of the two ads) initiates expansion of the thumbnail to the parent player canvas and begins playback of the selected ad. At step (6), the player with the embedded measurement API fires events back to the Player Controller 510, which manages state and dispatches the events to the VPAID Handler 506.

As mentioned above, VAST standardizes the communication requirements between video players and ad servers. According to the standard, to deliver a video ad within a video player, the video player makes an ad request to a VAST-compliant ad server. In response, the ad server returns a VAST data structure, typically in the form of XML, which declares the ad creatives to play, how they should be played, and what data to track. To facilitate the operation described above, an <AdParameters> element of a VAST response is extended by embedding XML configuration data therein. Preferably, the configuration data provided by the AdParameters extension as described herein includes: the collection of video ads to show and, for each video, a hierarchy of configuration including titles to display, third party tracking pixels to be dispatched on specific events, and ad context parameters to be applied to internal tracking events. Preferably, the ad unit VAST response wraps the XML configuration in CDATA tags to protect it from players that do not expect XML in this section of the response. Using XML in this manner and in this context provides significant additional benefits. In particular, it provides for a richer configuration, allowing for hierarchical data to be passed to the ad unit, as well as a better user experience by eliminating the need for the ad unit to make a separate request back to the ad server to fetch configuration.

The approach may be implemented by an advertising network, such as Visible Measures Viewable Media™, which provides the infrastructure for provisioning and configuring the ad unit, for managing decision logic, for receiving and exposing data associated with the ad unit, and the like. The ad unit itself may be delivered in any convenient manner, including through use of a third party delivery network (e.g., a content delivery network).

The disclosed technique provides a choice-based ad unit format wherein a user chooses his or her pre-roll ad or can choose to wait for the main content to load. Once the video advertisement selected loads, the user can then choose to skip the ad or view the entire ad experience. Preferably, the ad viewing experience is integrated with a site to enable the ad unit to have unlimited access to in-stream inventory that is otherwise available from the site. Thus, for example, the ad unit functionality described herein may be integrated at YouTube.com such that the YouTube® in-stream inventory is available to the unit and selection of one of the ads increments the YouTube view counter. This approach enables the ad network providing the ad units to be able to charge the advertiser an extremely low CPV, even where CPM bids are relatively high. The ad unit provides a very low-cost “promoted ad” solution to drive YouTube video views (or their equivalent for other sites) at large scale, as well as to target entertainment advertisers, price-conscious advertisers, and others. The approach leverages the scale of in-stream inventory (across exchanges and ad networks) while at the same time enables the network to increment views. By using rich media and VPAID 2.0 standards, an ad network provider can provide an in-stream solution that couples user-choice with pre-rolls to deliver YouTube (or the like) views inexpensively and at scale.

The reference to a particular video player herein is not intended to be limiting, as the approach may work with any third party video player that is VPAID-compliant, as has been described.

Generalizing, the approach leverages a VPAID-compliant parent media player that delegates control, via the VPAID interface, to multiple child player instances in the manner described. In particular, VPAID delegates control of the playback experience to the ad unit while retaining the parent player's ability to monitor the behavior of the ad unit for compliance with specific constraints such as, without limitation: overall time limit of ad experience, recovery on error, display state, ad dimensions, the time(s) the parent player takes control of the experience programmatically (e.g., pausing, muting or terminating playback altogether), and so forth.

To facilitate the described function, the backend ad server platform is modified to support multiple video ads (each a “creative”) in the VPAID/VAST responses. The approach described herein does not require host player or measurement system changes. In a typical event scenario as described, ads are shown side-by-side and an impression is fired for both. A “placement impression” may then be calculated (e.g., using a decision identifier to de-dupe the multiple impressions). Typically, a click is fired when a user selects the “click to learn more” link (a click-through). Normal ad/content events are fired during playback.

Because some media players do not provide a direct click event to indicate that a user has selected a video player thumbnail, preferably the ad unit's player wrapper class includes logic to monitor play state and to generate a video player-selected event when a first transition (e.g., from stopped to buffering or playing) is detected. To ensure that publisher content will play if a user is idle for more than a preset or configurable amount of time (e.g., 30 seconds), preferably the ad unit automatically starts the publisher content if an ad is not chosen by the user within that time (or if the ad is paused for greater than that time period).

In a preferred approach, the ad unit implements a multi-layered approach to tracking. In a first layer, standard VPAID events are dispatched to the parent player to permit publisher tracking. A second tracking layer includes an embedded measurement API to provide internal metrics and third party tracking for the ad video experience. That measurement API may track impressions, views, and quartile or decile engagement beacons. A third tracking layer provides for arbitrary events about the user's interaction with the ad unit to be dispatched, e.g., to aid in the understanding of the performance of the ad unit itself. Relevant data in this category may include click-throughs, skips, and timeouts. To further aid in understanding behavior, these tracking pixels may include context parameters, such as play-head position where the event occurred.

Because a parent VPAID player can stop or shutdown the ad experience at any time, preferably the ad unit also implements a delayed shutdown capability so that it can ensure that all ad unit components have properly terminated (i.e., cleaned-up resources, sent any pending tracking events, etc.) prior to complying with a termination request. To balance user experience with tracking efficiency, however, preferably there is a maximum shutdown delay that is triggered to limit the total amount of time that a user must wait for the ad unit to terminate and return control back to the parent media player.

Moreover, because the described approach leverages VPAID (and is thus standards-based), the solution is not tied to any specific publisher platform or inventory source. Further, because the approach leverages a third party video network, the ad views are countable in a universally-recognized currency (e.g., YouTube®-incrementing views).

While the above description sets forth a particular order of operations performed by certain embodiments, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computing entity selectively activated or reconfigured by a stored computer program stored. Such a computer program may be stored in a computer readable storage medium, such as, but is not limited to, any type of disk including an optical disk, a CD-ROM, and a magnetic-optical disk, flash memory, a read-only memory (ROM), a random access memory (RAM), a magnetic or optical card, or any type of non-transitory media suitable for storing electronic instructions.

While given components of the system have been described separately, one of ordinary skill will appreciate that some of the functions may be combined or shared in given instructions, program sequences, code portions, and the like.

The technique described herein may be implemented by any entity within the video advertising operating ecosystem including, for example, aggregators/distributors, ad serving technology vendors, web sites and portals, exchanges, advertising networks, measurement firms, video technology providers, and agencies.

Having described our invention, what we now claim is as follows:

1. A method of digital video advertising, comprising:
using software executing in hardware to deliver an ad unit entity in association with receiving a request for publisher content at a publisher site, the ad unit entity comprising, within a Flash SWF file, at least first and second child media players adapted to be instantiated in a parent media player, and application control logic, the child media players being individual instances of a third party player, the application control logic comprising a player class wrapper that encapsulates each child media player, a player controller class associated with the parent media player, and a handler that implements a control interface over which interactions between the player controller class and the parent media player are managed, the player controller class of the application control logic adapted to be executed in hardware:
(i) to display first and second thumbnails;
(ii) to receive data indicating a user choice of one of the first and second thumbnails;
(iii) to control a player class wrapper to expand a respective one of the first and second child media players into a frame of the parent media player and render video content associated with the user choice; and
(iv) to pass event data to facilitate an increment to a user-initiated view count for the publisher site following a rendering of at least a portion of the video content.

2. The method as described in claim 1 wherein the parent media player is a VPAID-compliant player that delegates control to the child media players over the control interface that is a VPAID interface.

3. The method as described in claim 2 wherein configuration data for the ad unit entity is passed over the VPAID interface as structured XML data within an ad parameter element.

4. The method as described in claim 1, wherein the publisher content is rendered in the parent media player after the video content renders in the child media player.

5. The method as described in claim 1 wherein the child media player is adapted to render the video content together with a skip control.

6. The method as described in claim 5 wherein, upon selection of the skip control, the publisher content is rendered in the parent media player irrespective of whether the video content has completed.

7. The method as described in claim 5 wherein the child media player is adapted to render the video content together with a link to a third party entity or page.

8. The method as described in claim 1 wherein the first and second thumbnails are displayed side-by-side.

9. The method as described in claim 1 wherein the first and second thumbnails are rendered together with a skip control.

10. The method as described in claim 9 wherein, upon selection of the skip control, the publisher content is rendered in the parent media player.

11. An article comprising a non-transitory machine-readable medium that stores a program, the program being executable in association with a VPAID-compliant parent media player to:
(i) initiate display of first and second thumbnails, the first and second thumbnails being associated with first and second child media players to which the parent media player has delegated control over a VPAID interface, each child media player being an individual instance of a third party player;
(ii) receive data indicating a user choice of one of the first and second thumbnails;
(iii) expand a respective one of the first and second media players into a frame of the parent media player and render video content associated with the user choice, and
(iv) pass event data to facilitate an increment to a user-initiated view count for a publisher site following a rendering by the respective one of the first and second media players of at least a portion of the video content;
the program being an SWF Flash file comprising, as application control logic, a player class wrapper that encapsulates each child media player, a player controller class associated with the VPAID-compliant parent media player, and a handler that implements the VPAID interface, wherein the player controller class is operative to carry out operations (i)-(iv).

12. The article as described in claim 11 wherein the parent media player delegates control by passing configuration data over the VPAID interface as structured XML data within an ad parameter element.

13. The article as described in claim 11 wherein the program is executable further to cause the parent media player to render the publisher content after the video content renders in the respective child media player.

14. The article as described in claim 11 wherein the program is executable further in response to receipt of a skip request to render the publisher content.

15. The article as described in claim 14 wherein the publisher content is rendered irrespective of whether the video content has completed.

16. A system, comprising:
server hardware and software upon which a network-accessible publisher site executes;
an inventory of in-stream video ads; and
an ad unit entity comprising, in combination as a Flash SWF file, at least first and second child media players adapted to be instantiated in a parent media player, and application control logic, the child media players being individual instances of a third party player, the application control logic comprising a player class wrapper that encapsulates each child media player, a player controller class associated with the parent media player, and a handler that implements a control interface over which interactions between the player controller class and the parent media player are managed;
the player controller class of the application control logic adapted to:
(i) display first and second thumbnails;
(ii) receive data indicating a user choice of one of the first and second thumbnails;
(iii) control a player class wrapper to expand a respective one of the first and second child media players into a frame of the parent media player and render video content associated with the user choice, the video content selected from inventory of in-stream video ads; and
(iv) pass event data to facilitate an increment to a user-initiated view count for the publisher site following a rendering of at least a portion of the video content.

17. The system as described in claim 16 wherein the parent media player is a VPAID-compliant player that delegates control to the child media players over the control interface that is a VPAID interface.

18. The system as described in claim 17 wherein configuration data for the ad unit entity is passed over the VPAID interface as structured XML data within an ad parameter element.
